(19) United States
(12) Patent Application Publication
(10) Pub. No.: US 2023/0251421 A1
(43) Pub. Date: Aug. 10, 2023

(54) PHOTONIC INTEGRATED CIRCUIT, AND OPTICAL TRANSMISSION MODULE

(71) Applicant: Fujitsu Optical Components Limited, Kawasaki-shi (JP)

(72) Inventors: Yuki YASUDA, Kawasaki (JP); Tetsuo ISHIZAKA, Inagi (JP); Tomoyuki ITO, Sapporo (JP); KENTA NOGAWA, Kawasaki (JP); TOSHIO ISHII, Yokohama (JP)

(73) Assignee: Fujitsu Optical Components Limited, Kawasaki-shi (JP)

(21) Appl. No.: 18/069,678

(22) Filed: Dec. 21, 2022

(30) Foreign Application Priority Data
Feb. 8, 2022 (JP) 2022-017636

(51) Int. Cl. G02B 6/12; H04B 10/80

(52) U.S. Cl. CPC G02B 6/12019; G02B 6/12004; H04B 10/801; G02B 2006/12147

(57) ABSTRACT

An optical transmission module includes a photonic integrated circuit, a processor that controls the power state of the photonic integrated circuit, and a current source circuit that supplies electric current to a light source used for the photonic integrated circuit. The photonic integrated circuit has an optical multiplexer block including a plurality of multiplexers connected in a n-level tree structure (n is an integer greater than 1), 2\hat{ }n optical modulators connected to inputs of the optical multiplexer block, and a photodetector connected to an input or an output of each of the plurality of the multiplexers. The light source emits a light beam to be incident onto a corresponding one of the 2\hat{ }n optical multiplexers. The processor controls the current source circuit for each of the plurality of the multiplexers, based on the monitored value acquired from the photodetector provided to each of the plurality of the multiplexers.

### CROSS-REFERENCE TO RELATED APPLICATIONS

This application is based upon and claims priority to earlier Japanese Patent Application No. 2022-017636 filed Feb. 8, 2022, which is incorporated herein by reference in its entirety.

### FIELD

The present documents relate to a photonic integrated circuit, and an optical transmission module.

### BACKGROUND

Arrayed waveguide gratings (AWGs) are often used in optical transceiver modules configured for multichannel fiber-optic communication, in order to multiplex and demultiplex optical signals of different channels. See, for example, Patent Document 1 presented below. By providing different optical path lengths between the arrayed waveguides corresponding to the wavelength spacing, a plurality of channels accommodating different wavelengths can be multiplexed and demultiplexed. In fiber-optic communication using a plurality of channels with different wavelengths, the power levels of the individual channels are initially regulated because the power varies among the channels due to the wavelength characteristics.

An AWG can multiplex and demultiplex a large number of channels with a single device, but its insertion loss is significant. Optical transmission modules dealing with large volume data transmission are required to reduce power consumption, while extending the transmission distances. Suppressing optical loss caused by optical components is one of the technical challenges. Meanwhile, power degradation occurs over time in individual channels even if the power variation is initially regulated among the channels. Not much attention has been paid to such channel-by-channel based power deterioration over time so far. It may be generally conceived to estimate the deterioration over time in advance and increase the optical output power anticipating the deterioration. However, increasing the optical output power expecting the future power deterioration is contradictory to the demand for low power consumption.

It is desired to provide a photonic integrated circuit that can suppress an increase of power consumption and inter-channel power variations, and to provide an optical transmission module using such a photonic integrated circuit.

A related art document known to the inventors is
Patent Document U.S. Pat. No. 7,697,580.

### SUMMARY

In one aspect, an optical transmission module includes
a photonic integrated circuit having an optical multiplexer block including a plurality of multiplexers connected in a n-level tree structure where n is an integer greater than 1, 2\hat{ }n optical modulators connected to inputs of the optical multiplexer block, and a photodetector connected to an input or an output of each of the plurality of the multiplexers;
a processor that controls a power state of the photonic integrated circuit; and
a current source circuit that supplies an electric current to light source configured to emit a light beam to be incident onto a corresponding one of the 2\hat{ }n optical modulators,
wherein the processor controls the current source circuit for each of the plurality of the multiplexers based on a monitored value acquired from the photodetector provided to each of the plurality of multiplexers.

The object and advantages of the invention will be realized and attained by means of the elements and combinations particularly pointed out in the claims. It is to be understood that both the foregoing general description and the following detailed description are exemplary and explanatory and are not restrictive to the invention as claimed.

### BRIEF DESCRIPTION OF DRAWINGS

FIG. 1 is a schematic diagram illustrating a basic configuration of a photonic integrated circuit according to an embodiment;

FIG. 2 is a modification of the photonic integrated circuit of FIG. 1;

FIG. 3 is a schematic diagram of a photonic integrated circuit using a set of optical multiplexers connected in a two-level tree structure;

FIG. 4 is a schematic diagram of a photonic integrated circuit using a set of optical multiplexers connected in a three-level tree structure;

FIG. 5 is a schematic diagram of an optical transmission module according to an embodiment;

FIG. 6 illustrates an example of decision parameter information saved in a memory;

FIG. 7A is a flowchart of power control performed in the optical transmission module;

FIG. 7B is a flowchart of power control following the process of FIG. 7A; and

FIG. 7C is a flowchart of power control following the process of FIG. 7B.

### EMBODIMENT(S)

Particular configurations of embodiments will be described below with reference to the drawings. The following descriptions illustrate just examples embodying the technical concept of the invention, and the invention is not limited to the following descriptions unless otherwise specified. The same configurational or functional elements are denoted by the same reference numerals, and redundant explanation is avoided.

### <Configuration Of Photonic Integrated Circuit>

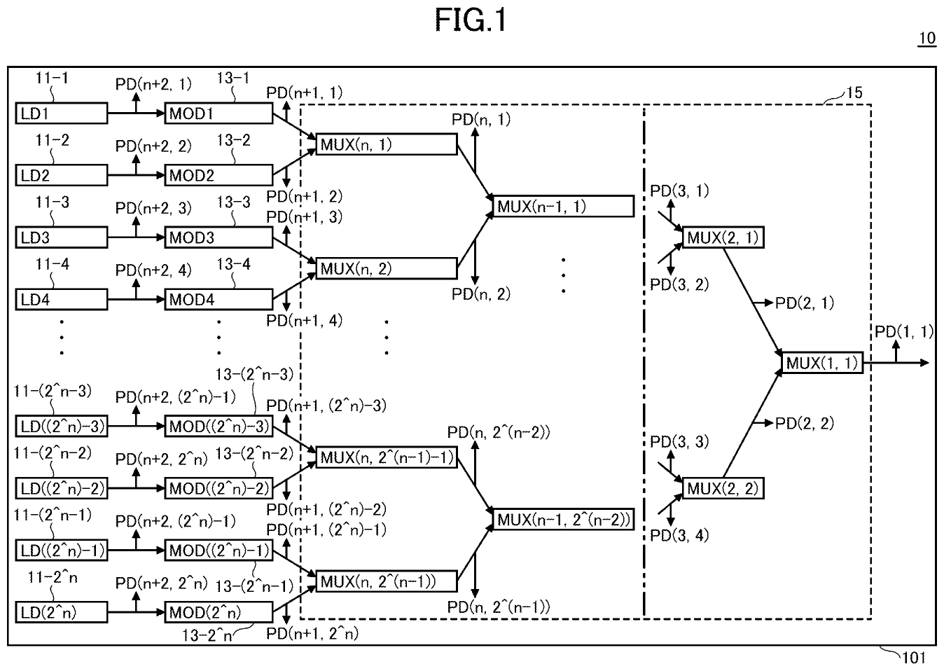

FIG. 1 is a schematic diagram illustrating the basic configuration of a photonic integrated circuit 10 according to an embodiment. The photonic integrated circuit is used in an optical transmission module of an embodiment, and particulars of the photonic integrated circuit are described first, before description is made of the configuration and operation of the optical transmission module of the embodiment. The photonic integrated circuit 10 has an optical multiplexer block 15, which is configured to multiplex a plurality of channels and has a plurality of multiplexers (labeled as “MUX” in the figure) connected in an n-level tree structure, where n is an integer greater than 1, namely, an integer greater than or equal to 2. By forming the optical multiplexer block 15 with the multiplexers connected in the tree structure, insertion loss is reduced compared with the conventional configuration using a single AWG. In addition, the power levels of the light beams input to and output from each of the multiplexers in the tree structure are monitored to identify the position where the power has deteriorated at each of the channels, which achieves the minimum necessary power compensation.

The optical multiplexer block 15 is formed on a substrate 101 of the photonic integrated circuit 10. The optical multiplexer block 15 has an n-level (n is an integer greater than 1) hierarchical or tournament tree structure. The stem of the tree is assumed to be the first-level multiplexer. Then, the second level, the third level, . . . , the (n−1)th level, and the n-th level are provided toward the end or leaf nodes of the tree. The number of multiplexers included in each level is 2\hat{ }(n−1) or 2 to the power of (n−1). The number of multiplexers in the first level is 2\hat{ }(1-1), which equals 1. This top multiplexer is denoted as MUX(1,1). The first number in the parentheses indicates which level of the n-level tree, and the second number indicates what number of multiplexers included in that level.

The second level of the tree includes two multiplexers, calculated from 2\hat{ }(2-1). The second-level multiplexers are denoted as MUX(2, 1) and MUX(2, 2), and so on up to the n-level multiplexers, which are denoted as MUX(n, 1), MUX(n, 2), . . . , MUX(n, 2\hat{ }(n−1)−1), and MUX(n, 2\hat{ }(n−1)).

The value of the integer n of the tree structure is determined by the number of channels accommodated in the photonic integrated circuit 10. The number of channels is determined by the number of optical modulators (each denoted as “MOD” in the FIG. 13 provided in the photonic integrated circuit 10. With the 2\hat{ }n (2 power n) optical modulators 13, an n-level tree structure of multiplexers is formed. Optical modulators 13-1 to 13-n are also provided in the photonic integrated circuit 10.

2\hat{ }n light sources 11-1, 11-2, . . . , 11-2\hat{ }n (which may be collectively referred to as “light sources 11”) are provided corresponding to optical modulators 13-1, 13-2, . . . , 13-2\hat{ }n (which may be collectively referred to as “optical modulators 13”). The light sources 11 are not necessarily provided in the photonic integrated circuit 10, and instead, an external light source array may be used as described later. In this example, the light sources 11 are laser diodes, and the 2\hat{ }n light sources 11 labelled as “LD1”, “LD2”, “LD(2\hat{ }n)” are integrated on the substrate 101.

In FIG. 1, a line connecting the multiplexers of the respective levels in the horizontal direction of the figure toward the top or the stem of the tree structure, MUX(1, 1), through which the optical signal modulated by one of the corresponding optical modulators 13 travels, may be called a “lane”. With the optical multiplexer block 15 formed in the n-level tree structure, the first to 2\hat{ }n-th lanes extend toward the top or the stem of the tree structure, i.e., multiplexer MUX(1, 1).

Photodetectors (PDs) are connected to the input and the output of each of the multiplexers that configure the optical multiplexer block 15. The photodetector connected to the output of the first-level MUX(1, 1) is denoted as PD(1, 1). This PD(1, 1) extracts a portion of the output light of the multiplexer MUX(1, 1) and monitors the power. PD(2, 1) and PD(2, 2) are respectively connected to the outputs of the second-level MUX(2, 1) and MUX(2, 2), and to the two inputs of the first-level MUX(1, 1) to monitor the power levels of the output lights of the MUX(2, 1) and MUX(2, 2). In the n-th level, PD(n, 1), PD(n, 2), . . . , PD(n, 2\hat{ }(n−1)−1), and PD(n, 2\hat{ }(n−1)) are connected to the outputs of the multiplexers MUX(n, 1), MUX(n, 2), . . . , MUX(n, 2\hat{ }(n−1)−1), and MUX(n, 2\hat{ }(n−1)) to monitor the power levels of the output lights from the corresponding multiplexers.

The power of the respective channels connected to the inputs of the optical multiplexer block 15 may be monitored. The inputs to the optical multiplexer block 15 formed in the n-level tree structure are namely the outputs of the optical modulators 13, and this level may be referred to as the (n+1)th level. In this case, PD(n+1, 1), PD(n+1, 2), . . . , PD(n+1, 2\hat{ }(n−1)−1), and PD(n+1, 2\hat{ }(n−1)) are connected to the outputs of the corresponding optical modulators 13 to monitor the power levels of the output lights from the respective optical modulators 13.

The power of the input stage of the optical modulators 13 may be monitored. The input stage of the 15 optical modulators 13 is referred to as the (n+2)th level. In this case, PD(n+2, 1), PD(n+2, 2), . . . , PD(n+2, 2\hat{ }(n−1)−1), and PD(n+2, 2\hat{ }(n−1)) are connected respectively to the inputs of the optical modulators 13. The set of photodetectors connected to the inputs of the optical modulators 13 may be called “second photodetectors” to distinguish them from the photodetectors connected to the inputs and outputs of the respective multiplexers of the optical multiplexer block 15.

The photonic integrated circuit 10 can be fabricated by, for example, silicon photonics technology. The optical modulators 13, as well as the multiplexers included in the optical multiplexer block 15, may be formed of silicon wire waveguides. Each of the optical modulators 13 may have a configuration in which silicon-wire Mach-Zehnder interferometers are nested according to the modulation scheme being used.

Each of the multiplexers may be configured as a Y-shaped optical coupler, a multi-mode interference (MMI) coupler, a directional coupler, or the like. With the Y-shaped optical coupler, a tap may be provided to the output waveguide of the Y-shaped optical coupler to extract a portion of the output light and monitor the power with the photodetector PD. When a 2-input 2-output MMI coupler, the split ratio of the two output ports may be controlled so that one output port is used for outputting the main signal and the other is used for power monitoring. The output power can be monitored by connecting a photodetector PD to the monitoring port. With the directional coupler, the coupling ratio of the output ports may be controlled so that one of the output waveguides is used for outputting the main signal, and that a photodetector PD is connected to the other output waveguide.

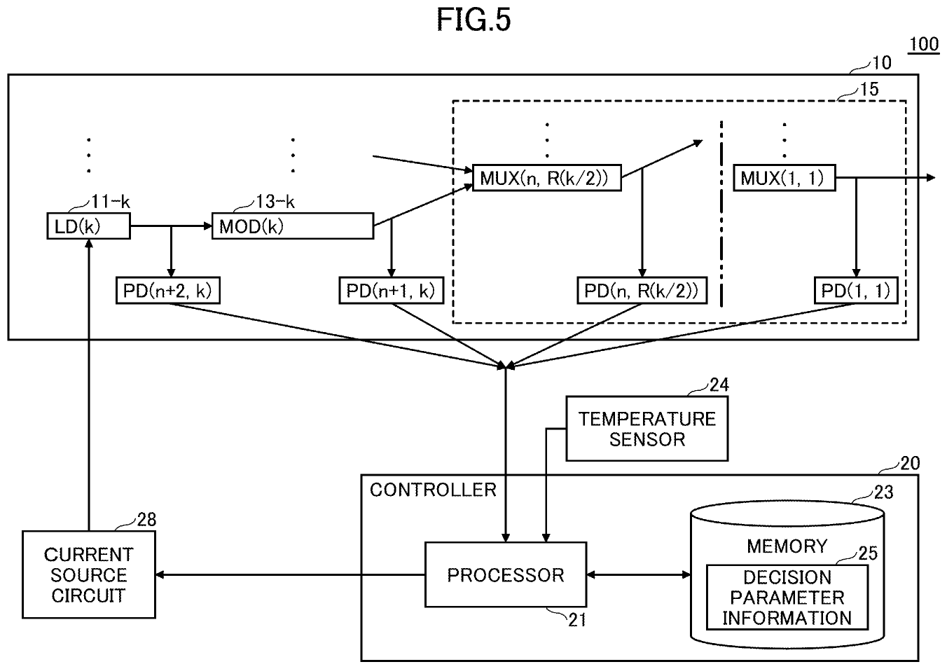

The electrical signals acquired from the respective PDs are supplied to a processor electrically connected to the photonic integrated circuit 10. The photonic integrated circuit is controlled so that optical power variations between channels are minimized or converged to the acceptable range. The particulars of the optical power control performed by the processor will be described later with reference to FIG. 5 and the subsequent figures.

By using the optical multiplexer block 15 with a multilevel tree structure in place of the conventional AWG to multiplex a plurality of channels, the optical loss can be reduced compared with using a single AWG. The insertion loss of each of the multiplexers is much smaller than that of the AWG, and the total loss of the entirety of the optical multiplexer block 15 is also less than that of the AWG. In addition, by monitoring the optical power at the output and input of each of the multiplexers, which position of which lane (or channel) the optical power has deteriorated in can be identified, and the minimum necessary power compensation can be performed.

The number of multiplexers included in the n-level tree structure of the optical multiplexer block 15 is (2\hat{ })−1. It may appear that the area size of the substrate 101 is greater than that of an AWG as the value of n increases. However, there is no significant difference in the area needed for multiplexing between the AWG and the configuration of the embodiment, because the AWG also requires a large area as the number of waveguides increases in order to provide a path length difference between each of the adjacent waveguides. Each of the multiplexers of the embodiment has a minute structure formed by silicon photonics technology, and the n-level tree structure can be formed within the area in which an array of 2\hat{ }n optical modulators 13 or 2\hat{ }n light sources 11 is provided.

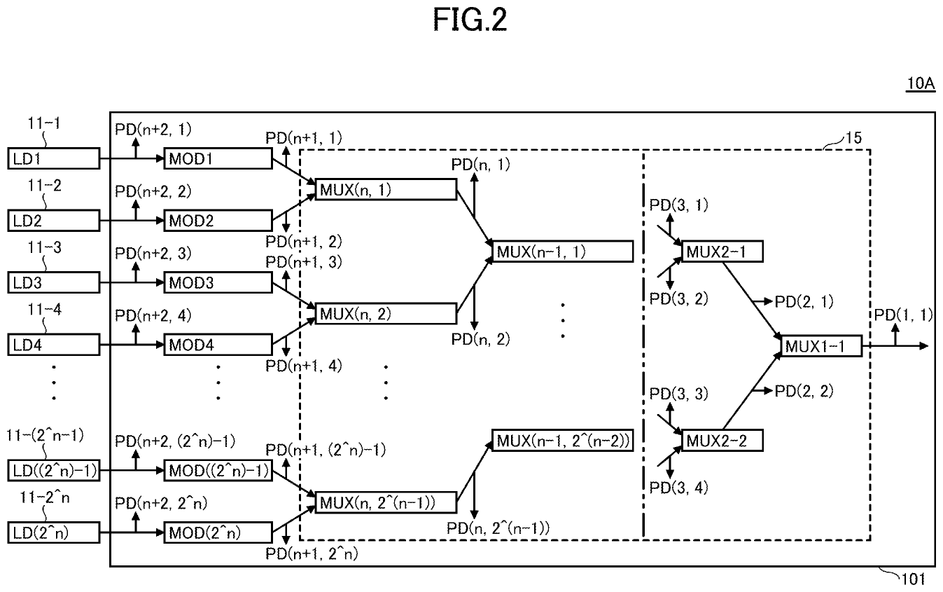

FIG. 2 is a schematic diagram of a photonic integrated circuit 10A, which is an alteration of FIG. 1. The photonic integrated circuit 10A has the same configuration as the photonic integrated circuit 10 except that the light sources 11-1 to 11-2\hat{ }n are provided outside the substrate 101. The optical multiplexer block 15 includes a plurality of multiplexers connected in an n-level tree structure (n is an integer greater than 1), and photodetectors connected to the input or output of each of the multiplexers.

The plurality of light sources 11-1, 11-2, 11-(2\hat{ }−1), and 11-(2\hat{ }n) may be fabricated in a laser array. The Light beams with different wavelengths are emitted from the respective light sources 11, and incident onto the corresponding optical waveguides formed on the photonic integrated circuit 10A through lensed fibers. Alternatively, spot size converters may be provided on the substrate 101. The end faces of optical fibers are abutted to the edge of the substrate 101, and connected to the optical waveguides on the substrate 101 via the corresponding spot size converters.

With the photonic integrated circuit 10A, the overall optical loss is reduced compared with the configuration using a single AWG. By monitoring the optical power at the output side and input side of each of the multiplexers, the location where the optical power has deteriorated can be identified, and power variation between channels can be suppressed by the minimum necessary power compensation.

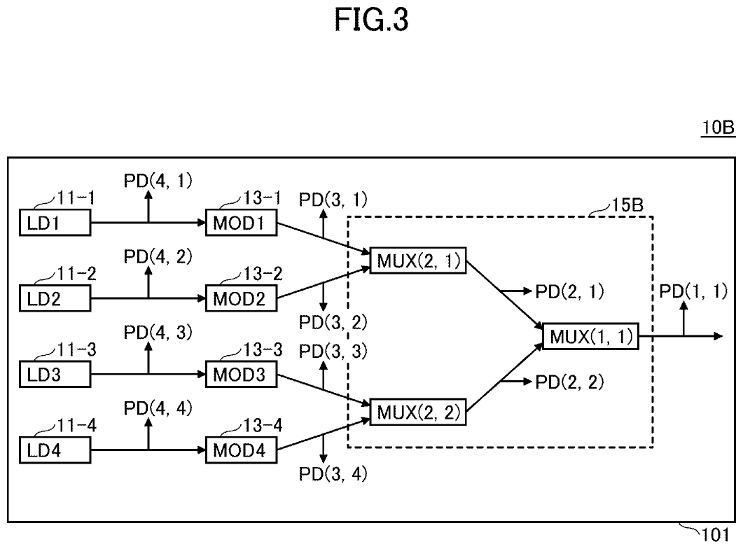

FIG. 3 is a schematic diagram of a photonic integrated circuit 10B which has an optical multiplexer block 15B with a two-level tree structure. The photonic integrated circuit 10B has the optical multiplexer block 15B that multiplexes four channels, and optical modulators 13-1, 13-2, 13-3, and 13-4. In this example, the light sources 11-1, 11-2, 11-3, and 11-4 are integrated on the substrate 101; however, an external light source array may be used separately from the substrate 101.

The number of multiplexers used in the two-level (n=2) tree structure is three, derived from (2\hat{ }2)−1. PD(1, 1) is connected to the output of the first-level multiplexer MUX(1, 1). PD(2, 1) and PD(2,2) are connected respectively to the outputs of the second-level multiplexers MUX(2, 1) and MUX(2, 2).

PD(3, 1), PD(3, 2), PD(3, 3), and PD(3, 4) are connected respectively to the outputs of the optical modulators 13-1, 13-2, 13-3, and 13-4 to monitor the optical powers at the input stage of the optical multiplexer block 15B. The PD(3, 1), PD(3, 2), PD (3,3), and PD(3, 4) connected to the inputs of the optical modulators 13-1, 13-2, 13-3, and 13-4 may be referred to as the second photodetectors.

The optical loss of each of the three multiplexers MUX(1, 1), MUX(2, 1), and MUX(2, 2) is very small, and the optical loss of the entirety of the optical multiplexer block 15B is also small. Even if the optical power deteriorates on any of the four channels, which position of which channel the optical power has deteriorated in can be identified. Power variations between channels can be controlled to be the minimum or within an acceptable range, by the minimum necessary power compensation.

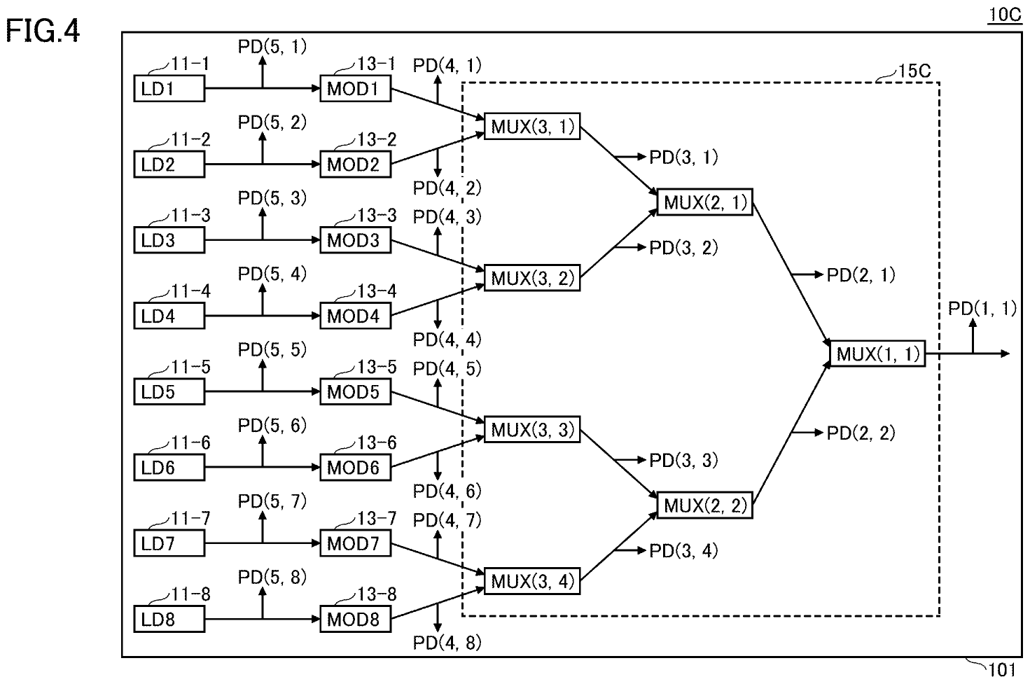

FIG. 4 is a schematic diagram of a photonic integrated circuit 10C having an optical multiplexer block 15C with a three-level tree structure. The photonic integrated circuit 10C has the optical multiplexer block 15C and optical modulators 13-1 to 13-8, and is configured to multiplex eight channels. Although light sources 11-1 to 11-8 are integrated on the substrate 101 in this example, an external light source array may be used separately from the substrate 101.

The number of multiplexers included in the three-level (n=3) tree structure is seven, derived from (2\hat{ }3)−1. PD(1, 1) is connected to the output of the first-level multiplexer MUX(1, 1). PD(2, 1) and PD(2, 2) are connected respectively to the outputs of the second-level multiplexers MUX(2, 1) and MUX(2, 2). PD(3, 1), PD(3, 2), PD(3, 3), and PD(3, 4) are connected respectively to the outputs of the third-level multiplexers MUX(3, 1), MUX(3, 2), MUX(3, 3), and MUX (3, 4).

PD(4, 1), PD(4, 2), PD(4, 3), PD(4, 4), PD(4, 5), PD(4, 6), PD(4, 7), and PD(4, 8) are connected respectively to the outputs of the optical modulators 13-1, 13-2, 13-3, 13-4, 13-5, 13-6, 13-7, and 13-8 to monitor the optical power at the input stage of the optical multiplexer block 15C. Additional PDs, namely, PD(5, 1), PD(5, 2), PD(5, 3), PD(5, 4), PD(5, 5), PD(5, 6), PD(5, 7), and PD(5, 8) may be connected respectively to the inputs of the optical modulators 13-1, 13-2, 13-3, 13-4, 13-5, 13-6, 13-7, and 13-8.

The optical loss of each of the seven multiplexers is small, and the total loss of the entirety of the optical multiplexer block 15C is also small. Upon deterioration of optical power having occurred in any of the eight channels, which position of which channel the optical power has deteriorated in can be identified. Power variations between channels can be controlled to be the minimum or within the acceptable range with the minimum necessary power compensation.

An optical multiplexer block with a four-level tree structure can also be fabricated by connecting fifteen (derived from (2\hat{ }4)−1) multiplexers in a hierarchical tree. In this case, sixteen (16) optical modulators 13 are provided, and 16 channels are multiplexed. The outputs of two adjacent optical modulators are connected to the inputs of the same multiplexer of the fourth-level of the tree. Even if the number of hierarchical levels is increased, the optical loss of each of the multiplexers is small, and the total loss can be suppressed compared with the conventional AWG configuration in which 16 arrayed waveguides are arranged with a certain path length difference provided between adjacent waveguides.

### <Optical Transmission Module>

FIG. 5 is a schematic diagram of an optical transmission module 100 according to an embodiment. The optical transmission module 100 includes a photonic integrated circuit 10 with an optical multiplexer block 15, a controller 20 that controls the power state of the photonic integrated circuit 10, and a current source circuit 28 that supplies electric current to the light sources 11. The optical transmission module 100 may include a temperature sensor 24.

For convenience of illustration, FIG. 5 focuses on the k-th lane (or channel) the photonic integrated circuit 10, while illustration of the other lanes is skipped because the multiple lanes have the same configuration except for the lane index, as illustrated in FIG. 1. In the optical multiplexer block 15, only the first-level multiplexer MUX (1, 1) and the n-th level multiplexer MUX (n, R(k/2)) connected to the output of the optical modulator 13-k of the k-th lane are illustrated, while the intermediate levels of the tree are omitted from the illustration. In the figure, R( ) represents the roundup function to an integer.

The light emitted from the k-th light source 11-k is modulated by the input data signal at the optical modulator 13-k. The power of the light beam incident onto the optical modulator 13-k is monitored by the PD(n+2, k), and the power of the light beam output from the optical modulator 13-k is monitored by the PD(n+1, k). The output of the optical modulator 13-k is connected to one of the two inputs of the n-th multiplexer MUX (n, R(k/2)). The optical signal travelling through the k-th lane is finally connected. to the input of the first-level multiplexer MUX(1, 1), and multiplexed with the optical signals of all the other channels. The power of the light beam output from the n-th multiplexer MUX (n, R(k/2)) is monitored by the PD(n, R(k/2)). The power of the light beam output from. the first-level multiplexer MUX(1, 1) is monitored by the PD(1, 1). At each node along the way toward the top of the tree structure, the input and output of the multiplexer are monitored by the corresponding PDs.

The controller 20 includes a processor 21 and a memory 23. The memory 23 saves decision parameter information 25 used for determining the acceptability of the power state of the light beam passing through each of the multiplexers. With the decision parameter information, it is determined whether the monitored value acquired from each of the PDs is within a prescribed range. The prescribed range indicates an acceptable range of the monitored value that each PD can take, and it may be represented as a voltage or a relative value with respect to the reference voltage. With the temperature sensor 24 being used, the memory 23 may save the prescribed ranges of the monitored value of each PD in association with different temperatures. The temperature sensor 24 is not essential; however, the control accuracy may slightly decrease without the temperature sensor because the margin of the decision parameter information 25 is set wide unless temperature information is used. With the temperature sensor 24, power variations between. channels can be suppressed accurately over a wide temperature range.

The monitored values of all the PDs are input to the processor 21. The monitored values may be temporarily saved in the temporary memory area of the memory 23. The processor 21 refers to the decision parameter information 25 saved in the memory 23, and determines whether or not the monitored value of each of the PDs is within the prescribed range. If the monitored value of a certain PD deviates from the prescribed range, the processor 21 controls the current source circuit 28 to regulate the electric current to be supplied to the corresponding light source 11 until the monitored value of the PD of interest falls within the prescribed range.

The input stage of the n-level tree structure of the optical multiplexer block 15 is the output stage of the optical modulators 13, and is referred to as the (n+1)th level, as has been described above. The input stage of the set of optical modulators 13 is referred to as the (n+2) level.

Focusing on the k-th lane, the processor 21 checks the monitored values starting from the PD (n+2, k) of the (n+2)th level closest to the light source 11 toward the top of the tree to control the light quantity of the corresponding light source 11. By tuning the light power tracing from the (n+2)th level to the top of the tree, power compensation can be minimized because even if the monitored value of an upper-level PD deviates from the prescribed range, power deterioration having occurred in the levels lower than that PD has already been corrected.

The same applies to the (n+1) th level. It is determined one by one for all the PDs in the (n+1)th level whether the monitored value is within the prescribed range. If the monitored value is out of the prescribed range, the light quantity of the corresponding light source 11 is tuned. Upon the current level supplied to that light sources 11 being changed based on the monitored value of the (n+1)th-level PD, the power of the light beam incident onto the corresponding optical modulator 13 changes, and consequently, the monitored value of the (n±2) th-level PD changes. This means that the appropriate range of the monitored value of that (n+2)th-level PD changes, and therefore, it is desirable to update the prescribed range of this (n+2; level PD described in the memory 23 as the decision parameter information 25. Since the (n+1) th level is the input stage to the optical multiplexer block 15, it is also desirable to tune the light quantity of the relevant light source 11 in consideration of the transmission characteristics of adjacent lanes connected to the same multiplexer.

From the n-th level to the first-level, the current value of the light source 11 is controlled based on the characteristics of the respective multiplexers included in the optical multiplexer block 15. Different lanes accommodate different wavelengths, and have different transmission characteristics. The multiplexing ratio of each multiplexer is determined according to the transmission ratio between the adjacent lanes connected to the same multiplexer. For example, if the transmission ratio between the first lane and the second lane is 1:2, the processor 21 controls the amount of current so that the power ratio between the corresponding light sources 11-1 and 11-2 is 2:1, it is assumed that the variation over time in the characteristic of each multiplexer negligible. The “variation over time” includes deterioration. over time or aging in characteristic such as power, due to temperature change Jr other factors.

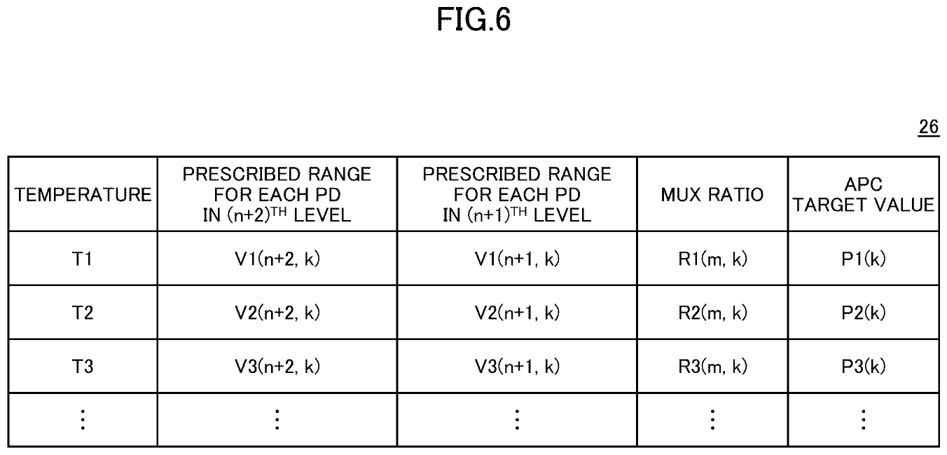

FIG. 6 illustrates a decision parameter table 26, which is an example of the decision parameter information 25. The decision parameter table 26 records, associated with temperature T, the prescribed range of the monitored value of each PD in the (n+2)th level, the prescribed range of the monitored value of each PD in the (n+1)th level, the multiplexing ratio (denoted as “MUX ratio” in the figure) of each multiplexer, and target value of automatic power control (APC) for each light source 11.

The prescribed range of the monitored value of each PD in the (n+2) th level at temperature T1 is represented as V1 (n+2, k), where k is an integer from 1 to 2\hat{ }. This field describes the prescribed range V1 for each of the 2\hat{ }. PDs included in the (n+2)th level. The prescribed range of the monitored value of each PD in the (n+1)th level at temperature T1 is represented as V1 (n+1, k), where k is an integer from 1 to 2\hat{ }n. This field describes the prescribed range V1 for each of the 2\hat{ }n PDs included in the (n+1)th level.

The multiplexing ratio of each multiplexer at temperature T1 is represented as R1(m, k). In this (2\hat{ }n)−1 multiplexing ratios R1 are described because the n-level tree structure includes (2\hat{ }n)−1 multiplexers, where in is an integer from 1 to n, and k varies depending on the value of m. Specifically, k in the m-th level is an integer from 1 to 2\hat{ }(m−1). The APP target value P1 (k) at temperature T1 is provided corresponding to each of the 2\hat{ }n light sources 11-1 to 11-2\hat{ }n. Therefore, 2\hat{ }n APC target values of P1 are described in this field.

Associated with temperature T2, the prescribed. range V2(n+2, k) of each PD in the (n+2)th level, the prescribed. range V2(n+1,k) of each. PD in the (n+1)th level, and the multiplexing ratio R2 (m, k) of each multiplexer, and APC target value P2 are also described in the corresponding line. The same applies when the temperature is T3 and so on. The step size of the temperature T is appropriately selected according to the environment in which the optical transmission module 100 is used, and it can be set to every 1° C., every 2° C., every 5° C., every 10° C., etc. Without using the temperature information, the temperature information column may be omitted from the table. In this case, the prescribed. range V(n+2, k) for each. PD in the (n+2)th level and the prescribed range V(n+1, k) for each PD in the (n+1)th level are set wide.

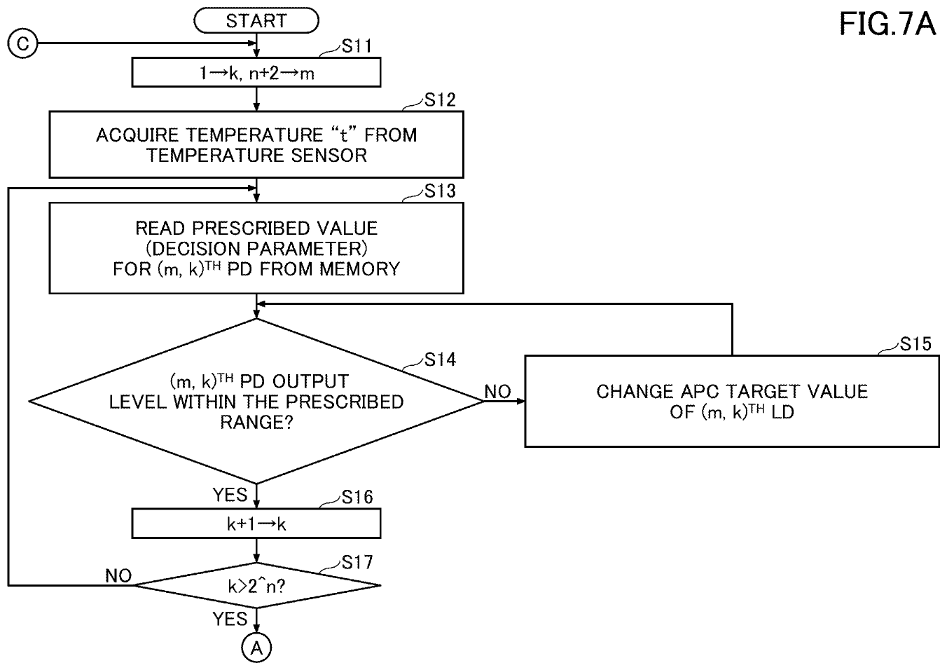

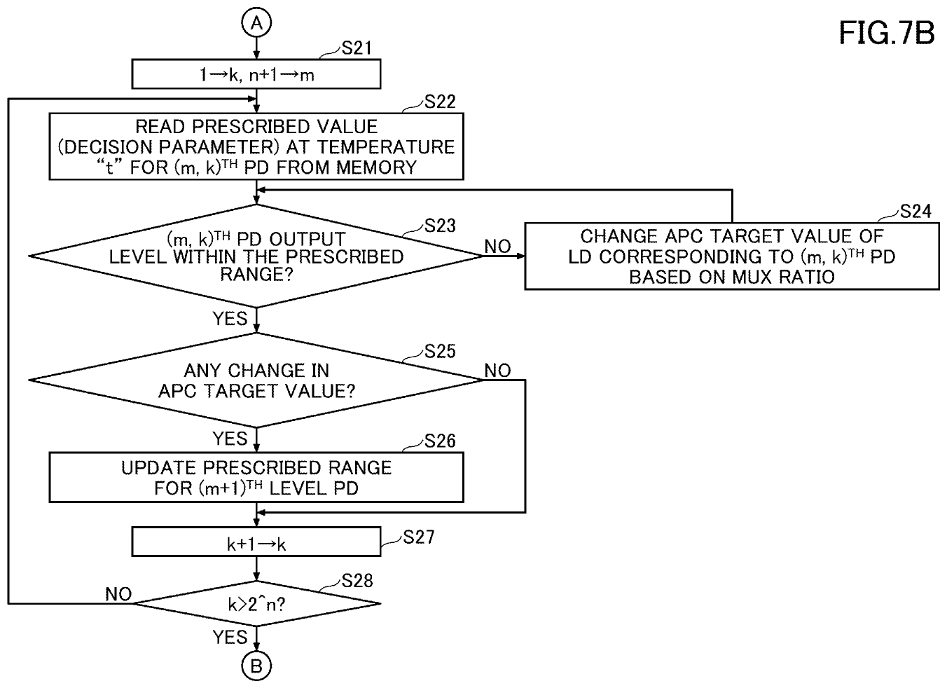

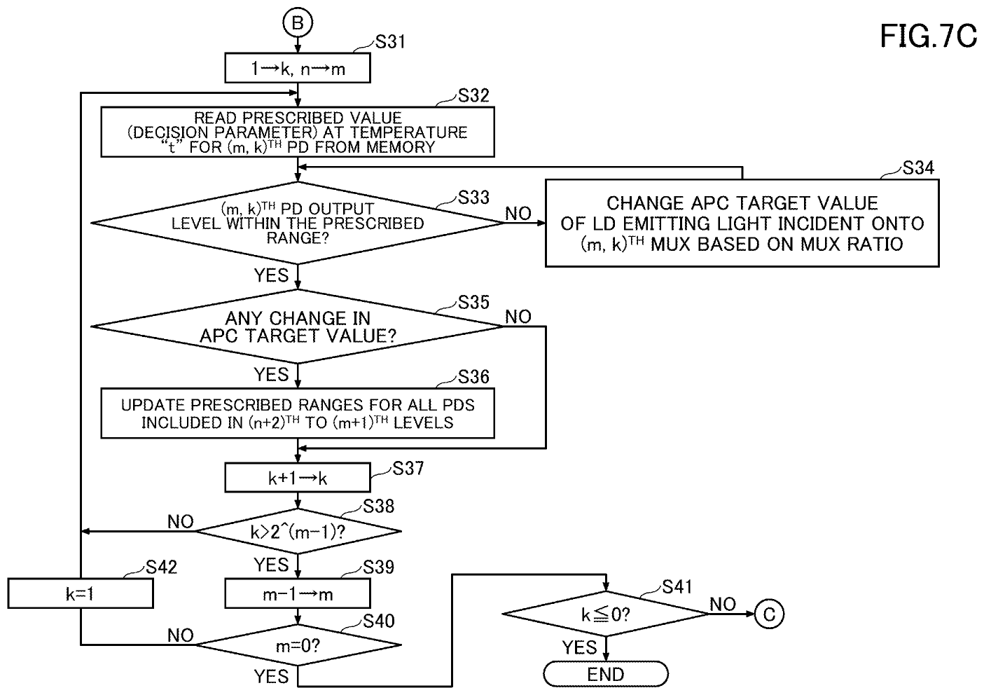

FIG. 7A, FIG. 7B, and FIG. 7C are flowcharts of power control executed by the processor 21. As a premise of this control flow, the optical transmission module 100 is in an activated state. The active state means that the optical transmission module 100 is in service, except immediately after startup. The control process illustrated in FIG. 7A to FIG. 7C are repeated periodically, non-periodically, or continuously during service. Another premise is that the temperature characteristics and wavelength characteristics of each of the optical modulators 13 and each of the multiplexers are measured and known in advance. The multiplexing ratios recorded in the decision parameter table 26 of FIG. 6 are determined based on the temperature characteristics and wavelength characteristics obtained in advance.

In FIG. 7A, the monitor values of the (n+2)th-level PDs are checked. Each of the PDs and each of the light sources (LD) 11 are specified using variables k and m, where m represents the hierarchical level starting from the top of the tree with an integer from 1 to n+2. As described above, n is the number of levels of the tree structure formed with the multiplexers, and is an integer greater than or equal to 2. Variable k is the index of each PD included in the m-th level. In the optical multiplexer block 15, the range of variable k varies depending on the m value, while k is an integer from 1 to 2\hat{ }n at the (n+2)th level and the (n+1)th level.

First, “1” is input to k, and “n+2” is input to m (S11). That is, the process focuses on the first PD of the (n+2)th level. The current temperature “t” is acquired from the temperature sensor 24 (S12). Based on the acquired temperature, the prescribed range of the (m, k)th PD, i.e., the k-th PD in the m-th level is read from. the memory 23 (S13). In the initial loop, the prescribed range of the first PD in the (n+2)th level is read. using the acquired prescribed range as the decision parameter for the (m, k)th PD, it is determined whether or not the monitored value of this PD is within the prescribed range (S14).

If the monitored. value of this PD is not within the prescribed range (NO in S14), the APC target value of the light source (LD) 11 corresponding to the (m, k)th PD is changed (S15). The step size for changing the APC target value is selected appropriately in advance. If the monitored value is less than the prescribed range, the current level supplied to the light source 11 is increased by one step. Steps S14 and S15 are repeated until the monitored value of the PD of interest falls within the prescribed range.

If the monitored value of the PD of interest is within the prescribed range (YES in S14), the value of k is incremented by 1 (S16), and it is determined. whether the incremented value of k exceeds 2\hat{ }n (S17). If the value of k is 2\hat{ }n or less (NO in S17), the process returns to step S13 and repeats steps S13 to 317. If the value of k exceeds 2\hat{ }n (YES in S17), it means that the monitored values of all the PDs included in the (n+2)th level have already been checked, and accordingly, the process proceeds to FIG. 7B.

The process illustrated in FIG. 7B continues from node A of FIG. 7A. In FIG. 7B, the monitored values of the PDs included in the (n+1)th level are checked. Value “1” is input to k, and “n+1” is input to m (S21). The process focuses on the first PD of the (n+1)th level. The prescribed range of the (m, k)th PD at temperature “t”, i.e., the k-th PD in the m-th level is read from the memory 23 (S22). In the initial loop, the prescribed range of the first PD in the (n+1)th level is read. Using the acquired prescribed range as the decision parameter for the (m, k)th PD, it is determined. whether or not the monitored value of this PD is within the prescribed range (S23).

If the monitored value of this PD is not within the prescribed range (NO in S23), the APC target value of the light source (LD) 11 corresponding to the (m, k)th PD is changed, based on the multiplexing ratio of the corresponding multiplexer (S24). The Multiplexing ratios recorded in the decision parameter information 25 or the decision parameter table 26 saved in the memory 23 are determined in advance based on the wavelength characteristics or temperature characteristics of each of the multiplexers. For, example, when the transmission ratio between the lane to which the PD of interest belongs and the adjacent lane connected to the input of the same multiplexer is 1:2, then the multiplexing ratio of this multiplexer is set to 2:1. The APC target value of the corresponding light source 11 is changed so that this multiplexing ratio is maintained. Steps S23 and S24 are repeated until the monitored value of the PD of interest falls within the prescribed range.

If the monitored value of the PD of interest is within the prescribed range (YES in S23), it is determined whether or not the APC target value has been changed (S25). If the APC target value has been changed (YES in S25), the prescribed range of the k-th PD in the (m+1)th level, that is, the (n+2) th level is updated (S26). This is because, upon adjustment of the light quantity of the corresponding light source 11 based on the monitored value of the k-th PD of the (n+1)th level, the power level of the light incident onto the corresponding optical modulator 13 changes, and consequently, the prescribed range for the (n+2)th-level PD changes. Then, the value of k is incremented by 1 (S27).

Without a change in the APC target value (NO in S25), the process proceeds directly to step S27 to increment the value of k. Then, it is determined whether the incremented value of k exceeds 2\hat{ }(S28). If the value of k is less than or equal to 2\hat{ }(NO in S28), the process returns to step S22 and repeats S22 to S28. If the incremented value of k exceeds 2\hat{ }n. (YES in S28), it means that the monitored values of all the PDs included in the (n+1)th level have been examined, and the process proceeds to FIG. 7C.

The process illustrated in FIG. 7C continues from node B of FIG. 7B. In FIG. 7C, monitored values of PDs are checked in order from the n-th level to the first level of the tree. A value “1” is input to k, “n” is input to m (S31), and the process focuses on the k-th PD of the m-th level (the first PD of the n-th level for the initial loop). The value of m is an integer from n back to 1. The prescribed range of the (m, k)th PD at current temperature “t” is read from. the memory 23 (S32) to determine whether the (m, k)th PD of interest is within the prescribed range (S33).

If the monitored value of this PD is not within the prescribed range (NO in S33), the APC target value of the light source (ED) 11 that has emitted the light beam. incident onto the MUX (m, k), i.e., the k-th multiplexer in the m-th level, is changed based on the multiplexing ratio of this MUX (m, k) (S34). Steps S33 and S34 are repeated until the monitored value of the PD of interest falls within the prescribed range.

If the monitored value of the PD of interest is within the prescribed range (YES in S33), then it is determined whether or not the APC target value has been changed (S35). With a change in the APC target value (YES in S35), the prescribed ranges of all the PDs from the (n+2) th level to the (m+1)th level of the corresponding lane, through which the light beam emitted. from the light source 11 whose light quantity has been adjusted travels, is updated (S36). This is because upon adjustment of the light quantity of the corresponding light source 11 based on the monitored value of the m-th level PD, the power of the light beam incident onto the corresponding optical modulator 13 changes, and consequently the prescribed ranges of the PDs provided for this lane up to the previous level change. After that, the value of k is incremented by 1 (S37).

If there is no change in the APC target value (NO in S35), the process proceeds directly to step S37 to increment the value of k, and it is determined whether the incremented value of k exceeds 2\hat{ }(m−1) (S38). If the value of k is equal to or less than 2\hat{ }(m−1) (NO in S38), the process returns to step S32 and repeats steps S33 to S38. If the value of k exceeds 2\hat{ }(m−1) (YES in S38), it means that the monitored. values of all the PDs in the m-th level have already been examined. In this case, the value of m is decremented by 1 (S39), and it is determined whether or not the decremented value of m has reached zero (S40). If the value of m is not zero (NO in S40), it means that there are still some levels left to be checked, so k is set to 1 (S42) to repeat steps S32 to S40. If the decremented value of m is zero (YES in S40), it means that there is no other hierarchical level left for determination in the tree. In this case, it is determined whether the value of k is zero or less (S41) in order to return the process to the (n+2)th level determination shown FIG. 7A to repeat the process. As long as the processor 21 operates normally, k is always an integer greater than zero (NO in S41). Accordingly, the process returns from node C to FIG. 7A to repeats the process from S11. If the value of k is zero or less (YES in S41), the process is terminated.

With this power control scheme, the location where the power has deteriorated is identified and the minimum necessary power compensation is performed. Increase in power consumption and power variation between channels can be suppressed. In addition, the insertion loss of the entirety of the multiplexers connected in a tree structure is smaller than that of a single AWG. In this regard, the power consumption is again suppressed. Using the photonic integrated circuit 10 (or 10A to 10C) of the embodiment, lane-by-lane based power control can be achieved.

Although the present disclosure has been. described based on specific configuration examples, the present disclosure is not limited to the examples described above. Although the light sources 11 are integrated on the substrate 101 in FIG. 5, the power control of FIG. 7A. to FIG. 7C may be performed on an external light source array. The decision parameter information stored in the memory 23 is not limited to the example of FIG. 6. The prescribed range may be listed for every PD for each temperature, or defined as a function.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of superiority or inferiority of the invention. Although the embodiments of the present inventions have been described in detail, it should be understood that the various changes, substitutions, and alterations could be made hereto without departing from the scope of the invention.

What is claimed is:

1. An optical transmission module comprising:
a photonic integrated circuit having an optical multiplexer block including a plurality of multiplexers connected in a n-level tree structure where n is an integer greater than 1, 2\hat{ }n optical modulators connected to inputs of the optical multiplexer block, and a photodetector connected to an input or an output of each of the plurality of the multiplexers;
a processor that controls a power state of the photonic integrated circuit; and
a current source circuit that supplies an electric current to a light source configured to emit a light beam to be incident onto a corresponding one of the 2\hat{ }n optical modulators,
wherein the processor controls the current source circuit for each of the plurality of the multiplexers based on a monitored value acquired from the photodetector provided to each of the plurality of the multiplexers.

2. The optical transmission module as claimed in claim 1, comprising:
a memory that saves decision parameter information used for determining acceptability of the power state of each of the plurality of the multiplexers,
wherein the processor determines whether the monitored value is within an acceptable range, referring to the decision parameter information, and adjusts the electric current supplied to the light source that emits the light beam to be incident onto a target multiplexer being controlled if the monitored value deviates from the acceptable range.

3. The optical transmission module as claimed in claim 1, comprising:
a memory that saves a multiplexing ratio of each of the plurality of the multiplexers,
wherein the processor adjusts the electric current supplied to the light source that emits the light beam to be incident onto a target multiplexer being controlled so that the multiplexing ratio of the target multiplexer is maintained.

4. The optical transmission module as claimed in claim 2,
wherein the memory saves a multiplexing ratio of each of the plurality of the multiplexers,
wherein the processor adjusts the electric current supplied to the light source that emits the light beam to be incident onto the target multiplexer being controlled so that the multiplexing ratio of the target multiplexer is maintained.

5. The optical transmission module as claimed in claim 2, comprising:
a second photodetector connected to an input of each of the 2\hat{ }n optical modulators,
wherein the memory saves second decision parameter information used for determining acceptability of a second monitored value acquired by the second photodetector, and
wherein the processor determines whether the second monitored value is within a second acceptable range, referring to the second decision parameter information, and after that, determines the acceptability of the power state of each of the plurality of multiplexers.

6. The optical transmission module as claimed in claim 2, comprising:
a temperature sensor,
wherein the memory saves the decision parameter information associated with a temperature, and
wherein the processor determines whether the monitored value is within the acceptable range based on temperature information acquired from the temperature sensor, and referring to the decision parameter information associated with the temperature.

7. A photonic integrated circuit comprising:
an optical multiplexer block including a plurality of multiplexers connected in a n-level tree structure where n is an integer greater than 1;
2\hat{ }n optical modulators connected to inputs of the optical multiplexer block;
a photodetector connected to an input or an output of each of the plurality of the multiplexers.

8. The photonic integrate circuit as claimed in claim 7, comprising:
2\hat{ }n second photodetectors, each being connected to an input of a corresponding one of the 2\hat{ }n optical modulators.

9. The photonic integrated circuit as claimed in claim 7, comprising:
2\hat{ }n light sources, each emitting a light beam to be incident onto a corresponding one of the 2\hat{ }n optical modulators.

10. The photonic integrated circuit as claimed in claim 8, comprising:
2\hat{ }n light sources, each emitting a light beam to be incident onto the corresponding one of the 2\hat{ }n optical modulators.

11. The photonic integrated circuit as claimed in claim 7,
wherein a part or all of the plurality of multiplexers is a Y-coupler, a multimode interference coupler, or a directional coupler.

12. The photonic integrated circuit as claimed in claim 8,
wherein a part or all of the plurality of multiplexers is a Y-coupler, a multimode interference coupler, or a directional coupler.

13. The photonic integrated circuit as claimed in claim 9,
wherein a part or all of the plurality of multiplexers is a Y-coupler, a multimode interference coupler, or a directional coupler.

14. The photonic integrated circuit as claimed in claim 10,
wherein a part or all of the plurality of multiplexers is a Y-coupler, a multimode interference coupler, or a directional coupler.
